(19) United States
(12) Patent Application Publication
(10) Pub. No.: US 2017/0288267 A1
(43) Pub. Date: Oct. 5, 2017

(54) Method for Forming Liquid Electrolyte-Containing Gel Electrolyte Membrane and Electrode Assembly, and Gel Electrolyte Cell and Method for Forming the Same, and Gel Polymer Lithium-Ion Battery

(71) Applicants: Xiaoli Peng, ChengDu (CN); Yong Xiang, ChengDu (CN); Chengxu Mou, ChengDu (CN); Li Xia, ChengDu (CN); Wanjin Pu, ChengDu (CN); Jinwei He, ChengDu (CN)

(72) Inventors: Xiaoli Peng, ChengDu (CN); Yong Xiang, ChengDu (CN); Chengxu Mou, ChengDu (CN); Li Xia, ChengDu (CN); Wanjin Pu, ChengDu (CN); Jinwei He, ChengDu (CN)

(73) Assignee: Interstellar Solid-State Li-ion Batteries Technology (Chengdu) Co., Ltd, ChengDu (CN)

(21) Appl. No.: 15/396,447

(22) Filed: Dec. 31, 2016

(30) Foreign Application Priority Data
Mar. 31, 2016 (CN) CN201610201104.8

(51) Int. Cl. H01M 10/0565; H01M 10/0525

(52) U.S. Cl. CPC H01M 10/0565; H01M 10/0525; H01M 2300/0085; H01M 2220/20

(57) ABSTRACT

The present disclosure provides a method for forming liquid electrolyte-containing gel electrolyte membrane and electrode assembly, and gel electrolyte cell and method for forming the same, and gel polymer lithium-ion battery. The method for forming the liquid electrolyte-containing gel electrolyte membrane, which includes the following steps, providing a cathode or an anode; forming a liquid mixture C and a liquid electrolyte D; forming a gel membrane on at least one surface of the cathode and/or the anode by the liquid mixture C; forming the liquid electrolyte-containing gel electrolyte membrane by the gel membrane absorbing the liquid electrolyte D. The electrode assembly, the gel electrolyte cell and the gel polymer lithium-ion battery obtained in the present disclosure have excellent liquid absorption performance of liquid electrolyte, a high electrolyte conductivity of 3 to 7*10⁻³S·cm⁻¹, a wide electrochemical window.

### BACKGROUND OF THE INVENTION

### Technical Field of Invention

The present disclosure relates to technologies of lithium-ion batteries, and particularly, to a method for forming liquid electrolyte-containing gel electrolyte membrane and electrode assembly, and gel electrolyte cell and method for forming the same, and gel polymer lithium-ion battery.

### Related Art

In the 21st century, with the development of the world economy, the improvement of people's living standards, the conflict between energy supply and energy demand is increasingly acute. At the same time, burning coal, oil and natural gas as the representative of the fossil fuel air pollution, greenhouse effect and other global problems seriously damaged the human living environment. In response to cope with the severe “energy crisis” and increasingly stringent environmental protection requirements, governments have introduced new energy policies to encourage the development of new green energy.

Chemical power (battery) as a convenient and fast storage of chemical energy, and storage of chemical energy can be efficient and pollution-free into electrical energy storage. Among the many chemical power sources, lithium-ion batteries have been widely used in the fields of portable electronic device, such as mobile phones, portable computers, camcorder, camera, etc., which have the characteristics of high energy density, high output voltage, large output power, self-discharge effect, wide working temperature, no memory effect and environmental friendliness. With the further development of science and technology and rapid decay of fossil energy, lithium-ion batteries which have widely used as a light-weight and high-energy power supplying for electric vehicles and hybrid electric vehicles, have been system-depth researched and developed, and commercial production.

Due to lithium-ion battery organic liquid electrolyte is prone to fluid leak which led to the occurrence of fire and explosion accidents in the case of battery abusing, internal short circuit and overheating, lithium-ion battery safety needs to be improved. As a special form of matter, a gel is neither a liquid nor a solid, but it can also be said to be both liquid and solid. This duality ensures that the gel has the nature of both solid which is adhesion, and liquid which can diffuse and transport of substances. The developed gel polymer electrolyte battery can significantly improve the safety of the liquid electrolyte lithium-ion battery, and the gel electrolyte is easy to be processed into various shapes of thin films, and then be processed into ultra-thin, different shapes of batteries which can adapt to miniaturized, thin, and light electronic products.

It is disclosed in the prior art that a method for preparing a lithium-ion battery gel electrolyte and a lithium-ion battery containing the gel electrolyte. The gel electrolyte includes a liquid electrolyte, a polymer component and an initiator. The gel electrolyte is prepared by adding an initiator one month before using. The method for packing battery, which includes the following steps: forming liquid electrolyte, forming a cell, encapsulating, baking, injecting liquid electrolyte, sealing, high-temperature initiation polymerization, forming, shaping, and degassing of the packed cell to obtain the gel polymer lithium-ion battery. The method of gel electrolyte preparation cycle is long. This method may occur thermal expansion, thermal drum phenomenon which affect the battery performance by using of thermal polymerization process. And thermal polymerization reaction is usually not very thorough, the residual monomer in turn will affect the entire battery electrochemical performance. In the prior art, it is also disclosed a gel polymer electrolyte with PAN (Peroxyacetic Nitrate) as skeleton matrix. The method for packing battery, which includes the following steps: forming PAN into microporous membrane, immersing in a self-made liquid electrolyte, 5 to 60 min, then the preparation of gel electrolyte is completed.

The processing is simple, first forming a microporous membrane, and then soaking the liquid. Finally, it is difficult to control the interfacial compatibility between the gel electrolyte membrane and the substrate of the cathode and anode by combining the membrane and the cathode and anode together to form a battery, which can effectively avoid the defects of the thermal polymerization process.

### SUMMARY OF THE INVENTION

Accordingly, one object of the present disclosure is to provide a method for forming a liquid electrolyte-containing gel electrolyte membrane, which includes the following steps, providing a cathode or an anode;

forming a liquid mixture C and a liquid electrolyte D;

forming a gel membrane on at least one surface of the cathode and/or the anode by the liquid mixture C; and

forming the liquid electrolyte-containing gel electrolyte membrane by the gel membrane absorbing the liquid electrolyte D.

The liquid mixture C includes a liquid mixture A and a liquid mixture B, the liquid mixture A including a polymer matrix and an organic solvent, and the liquid mixture B including an organic solvent and mixture additives. The liquid electrolyte D includes a lithium salt, a plasticizer, and electrolyte additives.

Another object of the present disclosure is to provide electrode assembly, which has a cathode and/or an anode; and a liquid electrolyte-containing gel electrolyte membrane formed on at least one surface of the cathode and/or the anode. The liquid electrolyte-containing gel electrolyte membrane is formed by a liquid mixture C forming a gel membrane on the at least one surface of the cathode and/or the anode and absorbing a liquid electrolyte D. The liquid mixture C includes a liquid mixture A and a liquid mixture B, the liquid mixture A including a polymer matrix and an organic solvent, the liquid mixture B including an organic solvent and mixture additives. The liquid electrolyte D includes a lithium salt, a plasticizer, and electrolyte additives.

A further object of the present disclosure is to provide a method for forming a gel electrolyte cell, which includes the following steps:

providing a cathode and an anode:

forming a liquid mixture C and a liquid electrolyte D;

forming a gel membrane on at least one surface of the cathode and/or the anode by the liquid mixture C;

forming a liquid electrolyte-containing gel electrolyte membrane by the gel membrane absorbing the liquid electrolyte D;

forming the gel electrolyte cell by the liquid electrolyte-containing gel electrolyte membrane. The liquid mixture C includes a liquid mixture A and a liquid mixture B, the liquid mixture A including a polymer matrix and an organic solvent, and the liquid mixture B including an organic solvent and mixture additives. The liquid electrolyte D includes a lithium salt, a plasticizer, and electrolyte additives.

Still a further object of the present disclosure is to provide a gel electrolyte cell, which has a cathode, an anode, and a liquid electrolyte-containing gel electrolyte membrane sandwiched between the cathode and the anode. The liquid electrolyte-containing gel electrolyte membrane is formed by a liquid mixture C forming a gel membrane on at least one surface of the cathode and/or the anode, and absorbing a liquid electrolyte D. The liquid mixture C includes a liquid mixture A and a liquid mixture B, the liquid mixture A including a polymer matrix and an organic solvent, and the liquid mixture B including an organic solvent and mixture additives. The liquid electrolyte D includes a lithium salt, a plasticizer, and electrolyte additives.

Yet another further object of the present disclosure is to provide a gel polymer lithium-ion battery, which has a gel electrolyte cell. The gel electrolyte cell includes a cathode, an anode, and a liquid electrolyte-containing gel electrolyte membrane sandwiched between the cathode and the anode, the liquid electrolyte-containing gel electrolyte membrane been formed by a liquid mixture C forming a gel membrane on at least one surface of the cathode and/or the anode, and absorbing a liquid electrolyte D, wherein the liquid mixture C includes a liquid mixture A and a liquid mixture B, the liquid mixture A including a polymer matrix and an organic solvent, the liquid mixture B including an organic solvent and mixture additives, and the liquid electrolyte D includes a lithium salt, a plasticizer, and electrolyte additives.

Other objects, advantages and novel features of the disclosure will become more apparent from the following detail description when taken in conjunction with the accompanying drawings.

### BRIEF DESCRIPTION OF THE DRAWINGS

The present disclosure will be described in more detail with reference to the accompany drawings and the embodiments, wherein in the drawings:

FIG. 1 is a flow chart of a method for forming a gel electrolyte cell in accordance with an embodiment of the present disclosure.

### DETAILED DESCRIPTION OF THE INVENTION

For clearly understanding technical features, purpose, and effect of the present disclosure, embodiments are given in detail hereinafter.

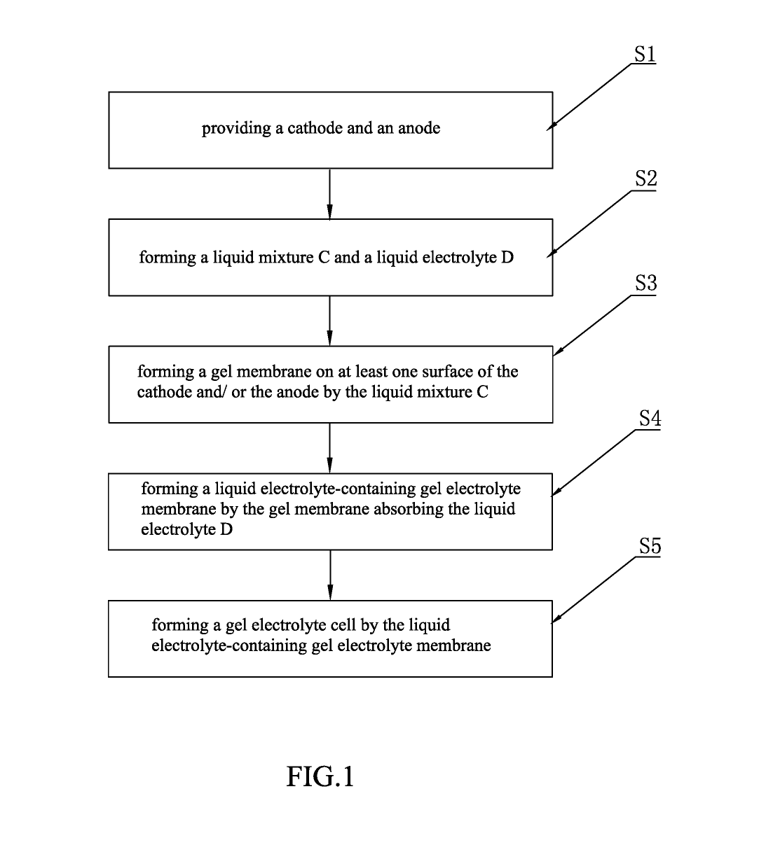

As shown in FIG. 1, the present disclosure provides a method for forming a gel electrolyte cell, including the following steps:

step S1, providing a cathode and an anode;

step S2, forming a liquid mixture C and a liquid electrolyte D;

step S3, forming a gel membrane on at least one surface of the cathode and/or the anode by the liquid mixture C;

step S4, forming a liquid electrolyte-containing gel electrolyte membrane by the gel membrane absorbing the liquid electrolyte D; and

step S5, forming the gel electrolyte cell by the liquid electrolyte-containing gel electrolyte membrane.

The liquid mixture C includes a liquid mixture A and a liquid mixture B, the liquid mixture A including a polymer matrix and an organic solvent, the liquid mixture B including an organic solvent and mixture additives. The liquid electrolyte D includes a lithium salt, a plasticizer, and electrolyte additives.

In some special embodiment of the present disclosure the gel membrane is a dry gel membrane which has more excellent liquid absorption performance.

The order between the above step S1 of providing a cathode and an anode and the step S2 is only illustrative and is not intended to specifically limit the method, for example, the cathode and/or the anode can be provided at the same time as the liquid mixture C and liquid electrolyte D is formed, or the cathode and/or the anode can be provided after the liquid mixture C and the liquid electrolyte D is formed.

The liquid mixture C includes the following components by mass fraction:

polymer matrix: 0.1 to 80%;

organic solvent: 10 to 99%; and

mixture additives: 0 to 50%.

The liquid electrolyte D includes the following components by mass fraction:

lithium salt: 0.1 to 50%;

plasticizer: 0.5 to 89%; and

electrolyte additives: 0 to 50%.

In step S2, forming the liquid mixture C and the liquid electrolyte D includes the following steps:

Step P1, forming the liquid mixture A, which includes the following steps: providing polymer matrix in mass fraction of 0.1 to 80%; and organic solvent in mass fraction of 5 to 55%; and mixing the polymer matrix and the organic solvent.

Step P2, forming the liquid mixture B, which includes the following steps:

providing mixture additives in mass fraction of 0 to 50%; and

organic solvent in mass fraction of 5 to 54%; and

mixing the mixture additives and the organic solvent.

Step P3, forming the liquid mixture C by mixing the liquid mixture A and the liquid mixture B.

Step P4, forming the liquid electrolyte D, which includes the following steps: providing

lithium salt in mass fraction of 0.1 to 50%;

plasticizer in mass fraction of 0.5 to 89%; and

electrolyte additives in mass fraction of 0 to 50%; and

mixing the lithium salt, the plasticizer and the electrolyte additives.

In the embodiment of Step P2, the mixture additives in the liquid mixture B can be one or a mixture of several materials selected from but not limited to the following groups: an plasticizer, an inorganic nanoparticles, an antioxidants, a surfactant, etc.

The type and amount of components of the mixture additives and the electrolyte additives may be adjusted according to the requirements of gel electrolyte cell, which is not limited here.

In the embodiment of step P4, the electrolyte additives can be one or a mixture of several materials selected from but not limited to the following groups: a surfactant, a flame retardant, a film former, an anti-overcharge additive, wetting additives, etc.

In the embodiment, the final state of the liquid mixture C is not directly related to the order of addition of the components constituting the liquid mixture A and the liquid mixture B.

The order between the above steps of forming the liquid mixture C and the liquid electrolyte D is not intended to specifically limit the method from Step P1 to Step P4, which is not limited here. For example, the liquid mixture C can be formed at the same time as the liquid electrolyte D is formed, or the liquid mixture C can be formed after the liquid electrolyte D is formed.

In still some preferred embodiments, the liquid mixture C includes the following components by mass fraction:

polymer matrix: 0.1 to 20%;

organic solvent: 60 to 90%; and

mixture additives: 0 to 10%.

The liquid electrolyte D includes the following components by mass fraction:

lithium salt: 0.1 to 20%;

plasticizer: 5 to 20%; and

electrolyte additives: 0 to 10%.

In some preferred embodiments, in the steps S2, the above components can be mixed and stirred at the following temperature: −10° C. to 0° C., −5° C. to 0° C., −1° C. to 3° C., 1° C. to 10° C., 10° C. to 15° C., 15° C. to 25° C., 25° C. to 30° C., or 25° C. to 28° C. The specific temperature can be: −10° C., −7° C., −3° C., 0° C., 4° C., 7° C., 10° C., 13° C., 15° C., 21° C., 25° C., 28° C., or 30° C.

In some embodiments, in the steps S2, the above components can be mixed and stirred for the following time: 0.5 h to 94 h, 1 h to 90 h, 5 h to 84 h, 10 h to 72 h, 24 h to 72 h, 24 h to 60 h, 24 h to 48 h, 24 h to 36 h, 24 h to 30 h, 0.5 h to 4 h, 0.5 h to 4.5 h, 1 h to 8 h, 0.5 h to 0.7 h, 1.5 h to 4.5 h, or 4.5 h to 8.5 h. The specific stirring time can be: 0.5 h, 1 h, 2.5 h, 4.5 h, 5 h, 7.5 h, 8 h, 9.5 h, 11.5 h, 13.5 h, 16.5 h, 18.5 h, 20.5 h, 24 h, 36.5 h, 45.3 h, 48 h, 69.5 h, 72 h, 78.5 h, 84 h, 88.5 h, 94.5 h, or 96 h.

In some embodiments, during forming the liquid mixture C, the stirring can be ultrasonic stirring or mechanical stirring. In some preferred embodiments, the ultrasonic stirring is employed for more uniform.

In some preferred embodiments, step S3 includes the following steps:

Step Q1, applying the liquid mixture C obtained in step S3 on at least one surface of the cathode and/or the anode.

Step Q2, evaporating the organic solvent of the liquid mixture C to grow the gel membrane in situ on at least one surface of the cathode and/or the anode.

The step Q2 can be carried out in a vacuum oven for vacuum drying at a temperature of −10 to 120° C. under a pressure of −5 to 5 Mpa, for 30 s to 24 h.

In a preferred embodiment, automatic ventilation may be carried out for 0 to 100 times during vacuum drying to keep the organic solvent of the liquid mixture C been exchanged out of the oven.

In step Q2, the drying step can be carried out at the following temperature: −10° C. to 110° C., −10° C. to 90° C., −10° C. to 30° C., 30° C. to 50° C., 50° C. to 80° C., or 80° C. to 120° C. The specific temperature can be: −10° C., 12° C., 17° C., 21° C., 27° C., 33° C., 39° C., 45° C., 48° C., 53° C., 57° C., 59° C., 61° C., 63° C., 68° C., 70° C., 71.5° C., 75° C., 78° C., 81° C., 83° C., 85° C., 87° C., 91° C., 93° C., 95° C., 99° C., 101° C., 105° C., 109° C., 112° C., 115° C., 117° C., 119° C., or 120° C.

In step Q2, the drying step can be carried out under the following pressure: −5 Mpa to 0 Mpa, −0.5 Mpa to 0 Mpa, 0 Mpa to 1 Mpa, 1 Mpa to 3 Mpa, or 3 Mpa to 5 Mpa. The specific pressure can be: −5 Mpa, −4.5 Mpa, −4 Mpa, −3.7 Mpa, −2.4 Mpa, −1.7 Mpa, −0.9 Mpa, −0.5 Mpa, −0.3 Mpa, −0.09 Mpa, −0.05 Mpa, −0.01 Mpa, 0 Mpa, 0.01 Mpa, 0.03 Mpa, 0.07 Mpa, 1 Mpa, 1.6 Mpa, 2.1 Mpa, 2.5 Mpa, 3.1 Mpa, 3.9 Mpa, 4.2 Mpa, 4.7 Mpa, or 5 Mpa.

In step Q2, the drying step can be carried out for the following time: 35 s to 24 h, 2 min to 23.5 h, 4 min to 22 h, 50 min to 20 h, 1 h to 19 h, 10 h to 24 h or 5 min to 2 h, etc. The specific time can be: 30 s, 35 s, 1 min, 2 min, 4 min, 26 min, 35 min, 41 min, 50 min, 1 h, 3 h, 4 h30 min, 6 h, 9 h, 10 h, 11 h, 11 h40 min, 13 h10 min, 16 h, 18 h20 min, 19 h, 20 h5 min, 22 h, 23 h or 24 h.

In some preferred embodiments, in step S4, the liquid electrolyte-containing gel electrolyte membrane can be formed by the following steps:

forming a cell without containing liquid electrolyte by packaging the cathode and the anode with the gel membrane grew in situ on the cathode and/or the anode sandwiched between the cathode and the anode;

forming a composite of liquid electrolyte-containing gel electrolyte membrane and the cell by absorbing the liquid electrolyte D through injecting the liquid electrolyte D to the gel membrane of the cell.

Then, in step S5, the gel electrolyte cell can be formed by forming, shaping, and degassing of the composite to obtain the gel electrolyte cell.

In other preferred embodiments, in step S4, the liquid electrolyte-containing gel electrolyte membrane can be formed by immersing the cathode and/or the anode with the gel membrane formed thereon in the liquid electrolyte D for 1 s to 24 h to form an electrode assembly of a liquid electrolyte-containing gel electrolyte membrane and the cathode and/or the anode.

Then, in step S5, the gel electrolyte cell is formed by packaging the processed cathode and/or the anode, with the liquid electrolyte-containing gel electrolyte membrane sandwiched between the cathode and the anode.

In some embodiment, the gel electrolyte cell is formed by laminating or wounding the processed cathode and the anode together with the gel electrolyte membrane sandwiched there between. There is no special requirements on the preparation temperature and gas atmosphere environment when forming the gel electrolyte cell, and therefore the method has wide applicability.

In some preferred embodiments, the liquid mixture C contains a volatile substance. During the forming of the gel membrane process, a part of the volatile substance is volatilized, thereby causing a phase separation. In step S3, the gel membrane is formed by uniformly growing in situ on the surface of the cathode and/or the anode with a certain thickness and a porous mesh structure. The thickness of the gel membrane ranges from 10 μm to 200 μm. The pore size of the gel membrane ranges from 50 nm to 2 μm. In some preferred embodiments, the gel membrane has the following thickness: 10 μm to 21 μm, 22 μm to 29 μm, 29 μm to 37 μm, 37 μm to 43 μm, 43 μm to 50 μm, 50 μm to 100 μm, 100 μm to 146 μm, 146 μm to 178 μm, or 178 μm to 200 μm. The special thickness can be: 10 μm, 11.5 μm, 13.2 μm, 14.1 μm, 15.4 μm, 15.7 μm, 16.0 μm, 16.3 μm, 16.7 μm, 17.1 μm, 17.5 μm, 19.3 μm, 21.7 μm, 23.4 μm, 25.9 μm, 27.6 μm, 29.0 μm, 30.1 μm, 31.6 μm, 32.5 μm, 33.8 μm, 34.9 μm, 35.7 μm, 36.1 μm, 36.7 μm, 37.8 μm, 38.4 μm, 39.6 μm, 39.9 μm, 40.1 μm, 41.2 μm, 42.5 μm, 43.6 μm, 44.7 μm, 48.6 μm, 48.9 μm, 49.5 μm, 50.0 μm, 63.1 μm, 74.5 μm, 81.2 μm, 89.3 μm, 91.7 μm, 95.6 μm, 101.0 μm, 103.6 μm, 107.9 μm, 121.8 μm, 131.0 μm, 145.0 μm, 151.2 μm, 166.2 μm, 178.3 μm, 181.5 μm, 189.2 μm, 196.3 μm, or 200 μm.

In the embodiment, the cathode can be one or more materials selected from but not limited to the following groups: lithium cobalt oxide, lithium manganese phosphate, lithium iron phosphate, nickel cobalt manganese ternary cathode material, and nickel cobalt aluminum ternary cathode material, etc. The anode may be one or a mixture of several materials selected from but not limited to the following groups: a carbon-based anode material, a lithium titanate, an alloy-based anode material, and a transition metal oxide anode material, etc.

The polymer matrix can be one or more materials selected from but not limited to the following groups of polyvinyl chloride (PVC), chlorinated polyvinyl chloride (CPVC), polystyrene (PS), polyethylene oxide (PEO), polymethylmethacrylate (PMMA), polyvinylidene fluoride (PVDF), polyacrylonitrile (PAN), vinylidene fluoride-hexafluoropropylene copolymer (PVDF-HFP), polyethylene (PE), methyl methacrylate (MMA), and thermoplastic acrylic resin (B72, B44), etc. In some preferred embodiments, the mass ratio of the polymer matrix to the liquid mixture C and the liquid electrolyte D is: 1 to 21%, 21 to 39%, 39 to 53%, 53 to 60%, 1 to 11%, 5 to 13%, 13 to 25%, or 33 to 59%, etc. In some more preferred embodiments, the special mass ratio of the polymer matrix to the liquid mixture C and the liquid electrolyte D can be: 1%, 2%, 2.5%, 3%, 5%, 4.5%, 6%, 7%, 8.6%, 9%, 9.3%, 10%, 10.1%, 13%, 14%, 16%, 18%, 20%, 21%, 25%, 27%, 30%, 32%, 34%, 35%, 37%, 40%, 42%, 45%, 47%, 50%, 53%, 57%, 59%, or 60%.

The organic solvent can be one or more materials selected from but not limited to the following groups of acetone, N-methylpyrrolidone (NMP), anhydrous ethanol, dimethyl sulfoxide (DMSO), dimethylformamide (DMF), tetrahydrofuran (THF), and ethyl acetate, etc. The mass ratio of the organic solvent to the liquid mixture C and the liquid electrolyte D is: 21 to 89%, 23 to 87%, 27 to 83%, 31 to 76%, 31 to 57 percent, 23 to 57%, 44 to 67%, 45 to 71%, 47 to 59%, 71 to 90%, 75.1 to 86.3%, or 78.2 to 85.2%, etc. In some more preferred embodiments, the specific mass ratio of the organic solvent to the liquid mixture C and the liquid electrolyte D can be: 27%, 32%, 35%, 39%, 41%, 43%, 46%, 47%, 49%, 51%, 55%, 57%, 63%, 65%, 67.6%, 70.2%, 74%, 78%, 81%, 83%, 85.2%, 85.6%, 87%, 90%, 92%, 95% or 98%.

The lithium salt can be one or more materials selected from but not limited to the following groups of lithium hexafluorophosphate (LiPF₆), lithium perchlorate (LiClO₄), lithium hexafluoroarsenate (LiAsF₆), lithium tetrafluoroborate (LiBF₄), lithium tetrachloroaluminate (LiAlCl₄), lithium bistrifluoromethanesulfonyl imide (LiN(CF₃SO₂)₂), lithium trifluoromethanesulfonate (LiCF₃SO₃), lithium diboxylate (LiB(C₂O₄)₂, lithium tetrafluoroborate (LiBF₃Cl), Lithium difluoroborate oxalate (LiODFB), lithium perfluoromethanesulfonate (LiCF₃SO₃), lithium fluoride (LiF), lithium carbonate (LiCO₃), and lithium chloride (LiCl), etc. The mass ratio of the lithium salt to the liquid mixture C and the liquid electrolyte D is: 0.1 to 0.99%, 1 to 47%, 2 to 45%, 4.5 to 42.5%, 7.6 to 41%, 8 to 39%, 11 to 37%, 15.1 to 36.7%, 39 to 41%, or 45 to 50%, etc. In some more preferred embodiments, the special mass ratio of the lithium salt to gel electrolyte precursor can be: 1%, 2.6%, 4.7%, 5.1%, 5.6%, 7%, 11.5%, 13.3%, 15.7%, 16.8%, 17.6%, 19.8%, 21.5%, 23.4%, 25.3%, 26.8%, 29.3%, 30.5%, 32.4%, 34.1%, 35%, 40%, 41.2%, 43.2%, 45.7%, 46.8%, 47.3%, 49.7%, or 50%.

The plasticizer may be one or more materials selected from but not limited to the following groups of propylene carbonate (PC), ethylene carbonate (EC), 1, 4-butyrolactone (γ-BL), diethyl carbonate (DEC), carbonic acid dimethyl carbonate (DMC), methyl ethyl carbonate (EMC), methyl propyl carbonate (EMP), and ethyl acetate (EA), etc. The mass ratio of the plasticizer to the liquid mixture C and the liquid electrolyte D is: 1 to 53%, 9 to 48%, 4.9 to 16.5%, 8.7 to 12.3%, 10.6 to 21%, 18 to 26.4%, 16 to 38.5%, 13 to 36.5%, 36.5 to 41.2%, 20.6 to 41.1%, 41 to 57%, or 53.5 to 60%, etc. In some more preferred embodiments, the special mass ratio of the plasticizer to the liquid mixture C and the liquid electrolyte D can be: 1%, 2.6%, 4.5%, 5.4%, 5.8%, 6.3%, 7.4%, 8.7%, 9.5%, 9.96%, 10.0%, 10.6%, 10.8%, 11.4%, 11.7%, 12.8%, 13.6%, 14.9%, 15.2%, 16.7%, 17.8%, 19.7%, 20.8%, 21.2%, 22.5%, 26.5%, 29.6%, 30.9%, 33.5%, 35.6%, 36.7%, 37.7%, 39.6%, 41.3%, 42.5%, 43.4%, 44.5%, 47.6%, 49.9%, 52.3%, 56%, 57.3%, 58.7%, 60%, 62.3%, 64.6%, 65.7%, 70.1%, 72.5%, 74.1%, 78.2%, 79.5%, 80.2%, 83.2%, 85.1%, 86.4%, 87.2%, 88.9% or 89%. In some embodiments, the plasticizer can be the main solvent of the liquid electrolyte D.

The inorganic material nanoparticles may be one or more materials selected from but not limited to the following groups of nano-silica (SiO₂), titanium dioxide (TiO₂), aluminum oxide (Al₂O₃), lithium metaaluminate (LiAlO₂), zeolite, lithium nitride Li₃N), and barium titanate (BaTiO₃), etc. The mass ratio of the inorganic material nanoparticles to the liquid mixture C and the liquid electrolyte D is: 0.001 to 39%, 2 to 37%, 4.5 to 34.5%, 1.2 to 12.5%, 12.5 to 14.5%, 15 to 23.1%, 23.5 to 35.2%, 29.1 to 34%, or 34 to 40%, etc. In some more preferred embodiments, the special mass ratio of the inorganic material nanoparticles to the liquid mixture C and the liquid electrolyte D can be: 0.001%, 0.008%, 0.013%, 0.015%, 0.021%, 0.032%, 0.045%, 0.0985%, 0.25%, 0.56%, 0.78%, 0.93%, 1%, 2.3%, 3.4%, 5%, 5.6%, 5.8%, 8.1%, 8.9%, 9.1%, 9.6%, 10.2%, 10.4%, 10.5%, 15.6%, 17.5%, 18.3%, 19.3%, 20.6%, 23.8%, 25.7%, 28.8%, 29.1%, 32.1%, 33.4%, 35.6%, 37.4%, 38.3%, 39.1%, 39.6%, or 40%.

The antioxidant may be one or more materials selected from but not limited to the following groups of antioxidant 1010, antioxidant 168, antioxidant 1076, antioxidant B900, antioxidant 3114, antioxidant 1098, antioxidant 245, etc. In some preferred embodiments, the mass ratio of the antioxidant to the liquid mixture C and the liquid electrolyte D is: 0.001 to 18%, 0.0022 to 15%, 0.01 to 11%, 0.04 to 9%, 0.07 to 8.6%, 0.1 to 3.4%, or 1% to 3%, etc. In some more preferred embodiments, the special mass ratio of the antioxidant to the liquid mixture C and the liquid electrolyte D can be: 0.001%, 0.024%, 0.01%, 0.041%, 0.056%, 0.07%, 0.1%, 0.13%, 0.21%, 0.54%, 0.8%, 1%, 5%, 8.2%, 10.1%, 13.4%, 15.6%, 17.8%, 18.1%, 19.6%, or 20%.

The surfactant can be one or more materials selected from but not limited to the following groups of fluorosurfactant (FS-3100), wetting agent (Dynol 607), wetting agent (Dynol 980), wetting agent (EnviroGem360), carboxymethyl cellulose sodium salt (CMC-Na), sulfuric acid ester salts (such as acrylonitrile-EPDM rubber-styrene copolymer (AES) surfactants, sodium sulfate, fatty alcohol polyoxyethylene ether (AEO-9)), coconut fatty acid diethanolamide, polyether modified polydimethylsiloxane, alkylphenolethoxylates (OP-10), 1-dodecylazepan-2-one, and various fluorine-containing surfactants, etc. The mass ratio of the surfactant to the liquid mixture C and the liquid electrolyte D is: 0.001 to 48%, 3 to 46%, 4.6 to 46.5%, 8.6 to 42.3%, 9.6 to 38.5%, 11 to 36.6%, 12 to 35.8%, 37% to 42.5%, 12 to 20.3%, or 42.5 to 50%. In some more preferred embodiments, the special mass ratio of the surfactant to the liquid mixture C and the liquid electrolyte D can be: 0.001%, 0.007%, 0.016%, 0.023%, 0.031%, 0.041%, 0.065%, 0.0985%, 0.21%, 0.49%, 0.85%, 0.97%, 1%, 2.3%, 4.4%, 5.7%, 5.9%, 6.1%, 7.3%, 8.6%, 9.3%, 10.2%, 11.6%, 12.4%, 13.3%, 14.7%, 15.8%, 16.5%, 17.1%, 17.9%, 18.2%, 18.5%, 20.9%, 23.5%, 26.4%, 29.1%, 30%, 33.5%, 37.6%, 38.9%, 42.2%, 46%, 47.3%, 48.9%, or 50%.

The flame retardant may be one or more materials selected from but not limited to the following groups of trimethyl phosphate (TMP), triethyl phosphate (TEP), triphenyl phosphate (TPP) and tributyl phosphate (TBP), monofluoromethyl (CH₂F-EC), difluoromethyl vinyl carbonate (CHF₂-EC), and vinyl trifluoro methyl carbonate (CF₃-EC), etc. In some preferred embodiments, the type and mass of the flame retardant may be added according to the requirements of the designed battery. The mass ratio of the flame retardant to the liquid mixture C and the liquid electrolyte D is: 0.001 to 19.8%, 2.6 to 19%, 3.1 to 18.7%, 3.7 to 17.6%, 4.5 to 15.6%, 5.6 to 14.3%, 1 to 5.6%, 5.6 to 12.4%, 12.5 to 18.4%, 18.4 to 19.6%, or 15.3 to 20%, etc. In some more preferred embodiments, the special mass ratio of the flame retardant to the liquid mixture C and the liquid electrolyte D can be: 0.001%, 0.007%, 0.016%, 0.023%, 0.031%, 0.041%, 0.065%, 0.0985%, 0.21%, 0.49%, 0.85%, 1.0%, 4.3%, 5.6%, 5.9%, 6%, 7%, 8.9%, 9.1%, 9.7%, 10.1%, 10.4%, 11.5%, 12.6%, 12.9%, 13.1%, 13.6%, 14%, 15%, 15.6%, 15.7%, 16.1%, 16.5%, 16.8%, 17.2%, 17.6%, 18.9%, 19.2%, 19.7%, or 20%.

The film former may be one or more materials selected from but not limited to the following groups of

a) gas film formers: sulfur dioxide (SO₂), carbon dioxide (CO₂), carbon monoxide (CO), and carbon disulfide (CS₂), etc;

b) liquid film formers: sulfurous acid esters (ES, PS, DMS, DES), anisole, vinylene carbonate (VC), tetrachlorethylene (TCE), acrylonitrile, vinyl acetate (VA), dimethylsalicylate, cyclopropylsulfoxide, methylene nitrite (ANN), thiophene, ethylenedioxythiophene, biphenyl, o-terphenyl, m-terphenyl, fluoroethylene carbonate, and DMSM, etc;

c) solid film formers: lithium carbonate (Li₂CO₃), lithium oxide (Li₂O), sodium perchlorate (NaClO₄), potassium carbonate (K₂CO₃), silver hexafluorophosphate (AgPF₆), copper trifluoroacetate (CuTF), calcium trifluoromethanesulfonate Ca(TFSA)₂, sodium chloride (NaCl), lithium trimethylsilane borate, and lithium silicate (Li₂SiO₃), etc. The mass ratio of the film formers to the liquid mixture C and the liquid electrolyte D is: 0.001 to 19.7%, 2.5 to 19.1%, 3.1 to 17.7%, 4.1 to 16.9%, 4.5 to 15.6%, 5 to 14.5%, 6 to 12.6%, 6.6 to 11.9%, 12.3 to 15.5%, 15.4 to 17.6%, or 17.3 to 20%, etc. In some more preferred embodiments, the special mass ratio of the film former to the liquid mixture C and the liquid electrolyte D can be: 0.001%, 0.007%, 0.016%, 0.023%, 0.031%, 0.041%, 0.065%, 0.0985%, 0.21%, 0.49%, 0.85%, 1.0%, 4.2%, 5.0%, 5.4%, 6.3%, 7.2%, 8.3%, 9.1%, 9.3%, 10.1%, 10.4%, 11.5%, 12.5%, 12.8%, 13.2%, 13.4%, 14.1%, 15.3%, 15.7%, 15.9%, 16.1%, 16.4%, 16.7%, 17.3%, 17.7%, 18.7%, 19.1%, 19.7%, or 20%.

The anti-overcharge additive may be one or more materials selected from but not limited to the following groups of

a) alkyl connected to aromatic ring, such as cyclohexyl benzene, cumene, tert-butyl benzene, or tert-pentyl benzene;

b) aromatic ring containing halogen, such as fluorobenzene, difluorobenzene, trifluorobenzene, or chlorobenzene;

c) aromatic ring with alkoxy, such as anisole, fluoroanisole, dimethoxybenzene, or diethoxy benzene;

d) aromatic carboxylic acid esters, such as dibutyl phthalate;

e) carboxylic acid ester containing benzene ring, such as tolyl carbonate or diphenyl carbonate; and

f) ferrocene, biphenyl, 3-chloromethoxybenzene or cyclohexylbenzene.

The mass ratio of the anti-overcharge additive to the liquid mixture C and the liquid electrolyte D is: 0.001 to 10%, 1.2 to 9.6%, 1.5 to 9.5%, 1.5 to 8.5%, 1.6 to 7.6%, 2.6 to 6.8%, 6.9 to 9.8%, 7.8 to 9.6%, 8.2 to 9.2%, 5 to 8%, or 9.1 to 9.9%, etc. In some more preferred embodiments, the special mass ratio of the anti-overcharge additive to the liquid mixture C and the liquid electrolyte D can be: 0.001%, 0.007%, 0.016%, 0.023%, 0.031%, 0.041%, 0.065%, 0.0985%, 0.21%, 0.49%, 0.85%, 1.0%, 2.3%, 2.6%, 2.7%, 3%, 3.2%, 3.9%, 4.1%, 4.7%, 5.1%, 5.4%, 5.9%, 6.6%, 6.9%, 7.1%, 7.6%, 7.9%, 8%, 8.6%, 8.7%, 9.1%, 9.5%, 9.8%, 9.9%, or 10%.

The present disclosure further provides a gel electrolyte cell in accordance with another embodiment. The gel electrolyte cell includes a cathode, an anode, and a liquid electrolyte-containing gel electrolyte membrane sandwiched between the cathode and the anode. The liquid electrolyte-containing gel electrolyte membrane is formed by a liquid mixture C forming a gel membrane on at least one surface of the cathode and/or the anode and absorbing a liquid electrolyte D.

The liquid mixture C includes a liquid mixture A and a liquid mixture B, the liquid mixture A including a polymer matrix and an organic solvent, and the liquid mixture B including an organic solvent and mixture additives. The liquid electrolyte D includes a lithium salt, a plasticizer, and electrolyte additives.

The type and mass fraction of the polymer matrix, the organic solvent, the lithium salt, the mixture additives, and the electrolyte additives are the same as that of the above described embodiment.

In the embodiments, the gel membrane has a porous mesh structure, and the thickness of the gel membrane is 10 to 200 μm. The gel membrane has an electrolyte retention of up to 95%. Therefore, it can be seen that the gel membrane provided by the embodiment has an excellent liquid absorption performance.

The present disclosure further provides a method for forming a gel polymer lithium-ion battery, which includes the following steps:

Step T1, providing a cathode and an anode;

Step T2, forming a liquid mixture C and a liquid electrolyte D;

Step T3, forming a gel membrane on at least one surface of the cathode and/or the anode by the liquid mixture C;

Step T4, forming a liquid electrolyte-containing gel electrolyte membrane by the gel membrane absorbing the liquid electrolyte D; and

Step T5, forming a gel electrolyte cell by the liquid electrolyte-containing gel electrolyte membrane and then forming the gel polymer lithium-ion battery by the gel electrolyte cell.

The liquid mixture C includes a liquid mixture A and a liquid mixture B, the liquid mixture A including a polymer matrix and an organic solvent, and the liquid mixture B including an organic solvent and mixture additives. The liquid electrolyte D includes a lithium salt, a plasticizer, and electrolyte additives.

The order between the above steps of the step T1 and the step T2 is only illustrative and is not intended to specifically limit the method. For example, the cathode and/or the anode can be provided after the liquid mixture C and liquid electrolyte D is formed.

The above steps and processing condition of step T2 to step T4 are the same as that of step S2 to step S4 in the above described embodiment.

It is to be noted that, prior to the above-described step T3, the cathode and/or the anode may be cut and pretreated. The pretreatment includes size cutting, water removal at high temperature, impurity removal and so on.

In some preferred embodiments, step T5 further includes packaging the gel electrolyte cell and then standing, forming, shaping, and degassing of the packed cell to obtain the gel polymer lithium-ion battery.

The present disclosure is to provide a gel polymer lithium-ion battery with a still another embodiment, which includes a gel electrolyte cell, the gel electrolyte cell includes a cathode, an anode, and a liquid electrolyte-containing gel electrolyte membrane sandwiched between the cathode and the anode. The liquid electrolyte-containing gel electrolyte membrane is formed by a liquid mixture C forming a gel membrane on at least one surface of the cathode and/or the anode and absorbing a liquid electrolyte D. The liquid mixture C includes a liquid mixture A and a liquid mixture B. The liquid mixture A includes a polymer matrix and an organic solvent, and the liquid mixture B includes an organic solvent and mixture additives. The liquid electrolyte D includes a lithium salt, a plasticizer, and electrolyte additives.

The method of forming the gel electrolyte cell and the gel polymer lithium-ion battery provided in the present disclosure has a good machinability, which can omit rolling the membrane and injecting liquid electrolyte comparing to conventional methods. Thus, it can save cost and improve production efficiency. The gel polymer lithium-ion battery has long life duration, high safety, good battery cycle performance, good interfacial compatibility and small interfacial resistance; even if the package of the battery is broken, the battery can continue to work without safety problems such as leakage of liquid, ignition, and even explosion.

The gel polymer lithium-ion battery can be designed according to specific purposes. In addition, due to simple technique, low cost of raw materials, low requirements for production environment, and low cost, the battery can be used for mass production of industrial products.

In the embodiment, the liquid electrolyte-containing gel electrolyte membrane grows in situ on at least one surface of the cathode and/or anode.

In the embodiment, the order of adding the component of the liquid mixture C and the component of the liquid electrolyte D is not limited.

In some preferred embodiments, the methods of immersing the gel membrane in the liquid electrolyte D; or injecting the liquid electrolyte D to the gel membrane to form the liquid electrolyte-containing gel electrolyte membrane; forming the gel electrolyte cell, and forming the gel polymer lithium-ion battery by the gel electrolyte cell are the same as that of the method in the third embodiment.

In order to further verify the liquid electrolyte-containing gel electrolyte membrane and the gel polymer lithium-ion battery, the present disclosure further provides experimental group and comparative group as follows.

Experiment 1

The steps of forming the gel polymer lithium-ion battery are as follows.

Forming the liquid mixture C.

The liquid mixture A and the liquid mixture B formed according to the following component proportions are respectively stirred at a temperature of 25° C. for 12 hours; after the liquid mixture A and the liquid mixture B are respectively well mixed, the liquid mixture A and the liquid mixture B are mixed at a temperature of 25° C. for 12 hours to form the liquid mixture C.

The proportions of the components of the liquid mixture A are as follows by mass fraction:

tetrahydrofuran: 34%;

polystyrene: 5%; and

polyethylene: 5%;

In the embodiment, tetrahydrofuran is used as organic solvent, polystyrene and polyethylene are used as polymer matrix.

The proportions of the components of liquid mixture B are as follows by mass fraction:

methyl carbonate: 15%;

ethylene carbonate: 5%;

antioxidant 1010: 2%

wetting agent (EnviroGem360): 1.8%; and

silica: 4%.

Coating the liquid mixture C on both sides of the cathode which is graphite.

After been coated, the cathode is dried in a vacuum oven under the pressure of −0.09 Mpa, at the temperature of 70° C. for 10 min, and automatic ventilation may be set to 1 time during vacuum drying to keep the organic solvent in the vacuum oven out of the oven. A gel membrane is forming on the substance on the cathode, when the tetrahydrofuran is volatizing, the gel membrane is formed by growing on the cathode.

The proportions of the components liquid electrolyte D at the temperature of 25° C. for 12 h are as follows by mass fraction:

methyl carbonate: 5%;

ethylene carbonate: 4%;

tetrahydrofuran: 10%;

methyl nitrite: 1.5%;

lithium trifluoromethanesulfonate: 7%;

wetting agent (EnviroGem360): 0.2%; and

tributyl phosphate: 0.5%.

Forming the liquid electrolyte-containing gel electrolyte membrane with a thickness of 55 μm by immersing the gel membrane formed on the cathode in the liquid electrolyte D for 1 min.

In the embodiment, lithium cobalt oxide is employed as the anode. The liquid electrolyte-containing gel electrolyte membrane formed on the cathode and the anode are alternately laminated to form a gel electrolyte cell with the liquid electrolyte-containing gel electrolyte membrane sandwiched between the cathode and the anode.

The a gel electrolyte cell is sealed, formed, shaped and degassed to form the gel polymer lithium-ion battery.

Experiment 2

The difference between Experiment 2 and Experiment 1 is that:

the proportions of the components of the liquid mixture A are as follows by mass fraction:

N-methylpyrrolidone: 40%;

polyvinylidene fluorine: 12%; and

vinylidene fluoride-hexafluoropropylene copolymer: 2%; The proportions of the components of liquid mixture B are as follows by mass fraction:

dimethyl carbonate: 6%;

methyl carbonate: 4%;

ethylene carbonate: 3%;

antioxidant B900: 2%;

fluorosurfactant (FS-3100): 0.2%; and

aluminum oxide: 3%.

Forming the liquid mixture C by mixing the liquid mixture A and the liquid mixture B. Forming a gel membrane on at the surface of the cathode by the liquid mixture C.

The composition of the gel membrane and the cathode, and the anode which is lithium cobalt oxide are alternately laminated to form a cell.

The proportions of the components of liquid electrolyte D are as follows by mass fraction:

dimethyl carbonate: 6%;

methyl carbonate: 4%;

ethylene carbonate: 2%;

methyl nitrite: 1.1%;

lithium tetrafluoroborate: 13.3%;

wetting agent (EnviroGem360): 0.4%; and

biphenyl: 1%.

Forming a liquid electrolyte-containing gel electrolyte membrane with a thickness of 50 μm by injecting the liquid electrolyte D with 3 ml of 1 Ah into the gel membrane. The liquid electrolyte-containing gel electrolyte membrane covers all the cathode.

Experiment 3

The difference between Experiment 3 and Experiment 1 is that:

The proportions of the components of the liquid mixture A are as follows by mass fraction:

anhydrous ethanol, dimethyl sulfoxide: 23%;

thermoplastic acrylic resin: 11%;

polystyrene: 7%;

The proportions of other components and other steps are the same as those of Experiment 1.

Experiment 4

The difference between Experiment 4 and Experiment 1 is that:

The proportions of the components of the liquid mixture A are as follows by mass fraction:

dimethylformamide: 36%;

polyvinylidene fluorine: 1%;

vinylidene fluoride-hexafluoropropylene copolymer: 3%;

The proportions of other components and other steps are the same as those of Experiment 1.

Experiment 5

The difference between Experiment 5 and Experiment 1 is that:

The proportions of the components of the liquid mixture B are as follows by mass fraction:

dimethyl carbonate: 2%;

methyl carbonate: 10%;

ethylene carbonate: 4%;

antioxidant B900: 3%;

fluorosurfactant (FS-3100): 0.8%;

aluminum oxide: 3%;

tetrahydrofuran: 10%.

The proportions of other components and other steps are the same as those of Experiment 1.

Experiment 6

The difference between Experiment 6 and Experiment 1 is that:

The proportions of the components of the liquid mixture B are as follows by mass fraction:

propylene carbonate: 6%;

antioxidant 3114: 3%;

carboxymethyl cellulose sodium salt: 0.8%;

aluminum oxide: 2%;

tetrahydrofuran: 20%;

The proportions of other components and other steps are the same as those of Experiment 1.

Experiment 7

The difference between Experiment 7 and Experiment 1 is that:

The proportions of the components of the liquid electrolyte D are as follows by mass fraction:

methyl ethyl carbonate: 9%;

tetrahydrofuran: 10%;

vinylene carbonate: 1.5%;

lithium perfluoromethanesulfonate: 7%;

wetting agent (EnviroGem360): 0.2%;

tributylphosphate: 0.5%.

The proportions of other components and other steps are the same as those of Experiment 1.

Experiment 8

The difference between Experiment 8 and Experiment 1 is that:

The proportions of the components of the liquid electrolyte D are as follows by mass fraction:

carbonic acid dimethyl carbonate: 3%;

ethylene carbonate: 2%;

tetrahydrofuran: 10%;

methyl nitrite: 1.5%;

lithium trifluoromethanesulfonate: 2%;

lithium tetrafluoroborate: 7%;

lithium hexafluorophosphate: 2%;

wetting agent (EnviroGem360): 0.2%;

tributylphosphate: 0.5%.

The proportions of other components and other steps are the same as those of Experiment 1.

Experiment 9

The difference between Experiment 9 and Experiment 1 is that:

drying the cathode after been coated the liquid mixture C in a vacuum oven under the pressure of 0.1 Mpa, at the temperature of 30° C. for 2 h.

The proportions of other components and other steps are the same as those of Experiment 1.

Experiment 10

The difference between Experiment 10 and Experiment 1 is that:

drying the cathode after been coated the liquid mixture C in a vacuum oven under the pressure of −0.1 Mpa, at the temperature of 120° C. for 1 h.

The proportions of other components and other steps are the same as those of Experiment 1.

The lithium-ion battery and its corresponding electrolyte as follows are prepared by adopting the technical scheme not described in the present disclosure.

Comparative Experiment 1

The difference between Comparative experiment 1 and Experiment 1 is that: The gel electrolyte membrane is replaced by a liquid electrolyte. The liquid electrolyte are mixed by the following components by mass fraction:

lithium bistrifluoromethanesulfonylimide: 18%;

diethyl carbonate: 8%;

ethylene carbonate: 5%;

ethyl acetate: 5%;

aluminum oxide: 1%;

vinylene carbonate: 2%;

tributyl phosphate: 1%; and

tetrahydrofuran: 60%.

The proportions of other components and other steps are the same as those of Experiment 1.

Comparative Experiment 2

Mixing ammonium salt and aluminum oxide in acetone. Adding vinylidene fluoride-hexafluoropropylene copolymer and stirring at the temperature of 25° C. to forming a gel. Forming a porous polymer electrolyte membrane by forming membrane with the volatile solvent after coating the gel on the glass plate at the temperature of 50° C., at the same time, ammonium salt decompose ammonia, carbon dioxide, water, which squeeze the membrane fluid to form the pores.

The components of ammonium salt, aluminum oxide and vinylidene fluoride-hexafluoropropylene copolymer by mass fraction is 10:5:15:15:55.

The proportions of other components and other steps are as the same as those of Experiment 1.

Comparative Experiment 3

A method for forming a gel polymer lithium-ion battery, which includes the following steps:

adding vinylidene fluoride-hexafluoropropylene copolymer in dimethyl sulfoxide to form a solution, in which the components of vinylidene fluoride, hexafluoropropylene and dimethyl sulfoxide by mass fraction is 21:15:65;

forming liquid precursor by string tetrabutyltitanate, ethylene glycol and acetylacetone, in which the components of tetrabutyltitanate and acetylacetone by mass fraction is 5:1;

forming a mixture by mixing the solution and the liquid precursor obtained above;

forming a liquid mixture of vinylidene fluoride-hexafluoropropylene-silica by adding tetrabutyltitanate and hydrochloric acid in mass faction of 20% into the above described mixture; wherein the mass fraction of vinylidene fluoride-hexafluoropropylene is 15%;

forming a porous membrane by coating the liquid mixture of vinylidene fluoride-hexafluoropropylene-silica on the surface of the cathode and/or the anode and further laminated to form a cell;

forming the gel polymer lithium-ion battery by injecting the electrolyte D in the porous membrane of the cell.

Further performance tests were performed on the above-mentioned experiments 1 to 10 and comparative experiments 1 to 3.

Electrolyte Conductivity Test

Experimental subjects: gel electrolyte membrane and electrolytes obtained in Experiments 1 to 10 and Comparative experiments 1 to 3;

Experimental method: forming a symmetrical blocked analog battery according to the structure of SS (stainless steel)|PE (gel electrolyte)|SS (stainless steel); testing the analog battery by a Princeton electrochemical workstation at a temperature of 25° C. at a frequency of 1 to 100000 Hz, and recording different conductivities obtained in the tests at different frequencies.

The conductivities of the gel electrolyte membrane obtained in Experiments 1 to 10 and Comparative experiments 1 to 3 are tested according to the above method. The results are as shown in the following Table 1.

TABLE 1
The electrolyte conductivities obtained in Experiments
1 to 10 and Comparative experiments 1 to 3.

| Subject | Conductivity (mS · cm⁻¹) |
|---|---|
| Experiment 1 | 4.8 |
| Experiment 2 | 4.6 |
| Experiment 3 | 3.0 |
| Experiment 4 | 3.8 |
| Experiment 5 | 5.0 |
| Experiment 6 | 4.0 |
| Experiment 7 | 4.3 |
| Experiment 8 | 6.8 |
| Experiment 9 | 4.8 |
| Experiment 10 | 2.0 |
| Comparative experiment 1 | 2.2 |
| Comparative experiment 2 | 1.0 |
| Comparative experiment 3 | 0.8 |

Analysis of the experimental results: as can be seen from Table 1, the conductivities of the gel electrolyte membrane obtained in Experiments 1 to 10 is higher than that of the gel electrolyte membrane obtained in Comparative experiments 1 to 3.

Electrochemical Window Test of Gel Electrolyte

Experimental subjects: the liquid electrolyte-containing gel electrolyte membrane formed in Experiments 1 to 10, and the gel electrolyte formed in Comparative experiments 1 to 3.

Experimental method: forming an asymmetric coin cell according to the structure of Li (metal lithium)|PE (gel electrolyte)|SS (stainless steel), wherein Li is the auxiliary electrode and reference electrode and SS is the working electrode; testing the gel electrolyte membrane by a Princeton electrochemical workstation in a RT of 25° C. at a scanning rate of 5 mV/s; and recording the obtained electrochemical window to obtain a linear voltammetry graph.

The results are as shown in the following Table 2.

TABLE 2
The electrochemical window obtained in Experiments
1 to 10 and Comparative experiments 1 to 3

| Experimental subject | electrochemical window (V) |
|---|---|
| Experiment 1 | 4.55 |
| Experiment 2 | 4.8 |
| Experiment 3 | 4.4 |
| Experiment 4 | 4.4 |
| Experiment 5 | 4.5 |
| Experiment 6 | 4.4 |
| Experiment 7 | 4.4 |
| Experiment 8 | 4.8 |
| Experiment 9 | 4.4 |
| Experiment 10 | 4.42 |
| Comparative experiment 1 | 4.4 |
| Comparative experiment 2 | 3.8 |
| Comparative experiment 3 | 4.3 |

Analysis of the experimental results: as can be seen from Table 2, the electrochemical window of the liquid electrolyte-containing gel electrolyte membrane obtained in Experiments 1 to 10 is greater than the gel electrolyte membrane obtained in Comparative experiments 1 to 3.

In order to compare the cycle performance of the gel polymer lithium-ion battery obtained in the present disclosure according to Experiments 1 to 10 and Comparative experiments 1 to 3, following tests of cell capacity retention and coulomb efficiency of the battery are carried out.

Capacity Retention Test of Lithium-Ion Battery

Experimental subjects: Experiments 1 to 10 and Comparative experiments 1 to 3. Experimental method: 1) charging the battery with a constant 0.2 C current until the voltage reaches 4.2 V; 2) charging the battery at a constant voltage of 4.2 V until the current reaches 0.05 C; 3) discharging the batteries with a constant current 0.2 C until the voltage reaches 3 V; repeating the above steps 1) to 3), and recording the number of cycles and the corresponding capacity retention rates.

Experimental results: the capacity retention rates of the gel polymer lithium-ion battery of Experiment 1 to 10 and Comparative experiments 1 to 3 is shown in Table 3. The results are as shown in the following Table 3.

TABLE 3
The capacity retention rates obtained in Experiments
1 to 10 and Comparative experiments 1 to 3.

| Experimental subject | Capacity retention rate |
|---|---|
| Experiment 1 | 92.3% |
| Experiment 2 | 94.7% |
| Experiment 3 | 94.1% |
| Experiment 4 | 95.8% |
| Experiment 5 | 94.4% |
| Experiment 6 | 94.7% |
| Experiment 7 | 95.1% |
| Experiment 8 | 92.6% |
| Experiment 9 | 91.3% |
| Experiment 10 | 90.8% |
| Comparative experiment 1 | 50.7% |
| Comparative experiment 2 | 68.4% |
| Comparative experiment 3 | 70.6% |

Analysis of the experimental results: as can be seen from Table 3, the capacity retention rate of the liquid electrolyte-containing gel electrolyte membrane obtained in Experiments 1 to 10 is better than the gel electrolyte membrane obtained in Comparative experiments 1 to 3.

First-Week Coulomb Efficiency Test of Gel Polymer Lithium-Ion Battery

Experimental subject: Experiments 1 to 2.

Experimental method: charging the batteries and recording the charging capacities, discharging the batteries and recording the discharging capacities, calculating the first-week coulomb efficiencies of the batteries based on the recorded charging capacities and the discharging capacities according to the calculating formula of the coulomb efficiency: coulomb efficiency=first-week charging capacity/first-week discharging capacity*100%.

Experimental results and analysis: the first-week coulomb efficiency of the gel polymer lithium-ion battery obtained in Experiment 1 is greater than 90%.

The first-week coulomb efficiency of the gel polymer lithium-ion battery obtained in Experiment 2 is greater than 90%.

Electrochemical Performance Test after Damage of Lithium-Ion Battery

Experimental subjects: Experiments 1 to 10 and Comparative experiments 1 to 3;

Experimental method: fully charging the batteries and cutting the batteries from the middle thereof by scissors, and observing and recording the states of the batteries; and connecting a small fan to the cut batteries respectively and observing the working states of the small fan.

Experimental results: results of the tests are as shown in Table 4.

TABLE 4
electrochemical performance tests after damage of the
lithium-ion batteries obtained in Experiments 1 to 10 and
Comparative experiments 1 to 3:

| Experimental | | | Liquid | Rotation of |
|---|---|---|---|---|
| subjects | Ignition | Smoke | flowed out | small fan |
| Experiment 1 | No | No | No | Yes |
| Experiment 2 | No | No | No | Yes |
| Experiment 3 | No | No | No | Yes |
| Experiment 4 | No | No | No | Yes |
| Experiment 5 | No | No | No | Yes |
| Experiment 6 | No | No | No | Yes |
| Experiment 7 | No | No | No | Yes |
| Experiment 8 | No | No | No | Yes |
| Experiment 9 | No | No | No | Yes |
| Experiment 10 | No | No | No | Yes |
| Comparative | Yes | Yes | Yes | No |
| experiment 1 | | | | |
| Comparative | Yes | Yes | No | No |
| experiment 2 | | | | |
| Comparative | Yes | Yes | No | No |
| experiment 3 | | | | |

Analysis of the experimental results are as follows.

As can be seen from Table 3, in Experiments 1 to 10 provided by the present disclosure, after the gel polymer lithium-ion battery is cut from the middle thereof, the battery neither ignites nor smokes, and no liquid flows out of the battery, thus, the battery has a higher safety. In addition, when the cut battery is connected to the small fan, the small fan can continue to work.

In Comparative experiments 1 to 3, after the lithium-ion battery is cut from the middle thereof, the battery ignites and smokes, and cannot continue to work. In addition, in Comparative experiment 1, there is further liquid leakage out of the battery, which brings great safety risks in the use of the battery.

In Experiments 1 to 2, after the gel polymer lithium-ion battery is cut from the middle thereof, the capacity of the battery is 2 Ah, the power of the small fan is 5 W. After the lithium-ion battery is cut from the middle thereof, the battery and can continue to work, which has high security in the use of the battery.

Compared with the prior art, the method for forming liquid electrolyte-containing gel electrolyte membrane and electrode assembly, and gel electrolyte cell and method for forming the same, and gel polymer lithium-ion battery provided in the present disclosure have technical effects as follows.

In the method for liquid electrolyte-containing gel electrolyte membrane provided in the present disclosure, the liquid mixture C and the liquid electrolyte D are formed; a gel membrane is grew in situ on at least one surface of the cathode and/or the anode by the liquid mixture C; a liquid electrolyte-containing gel electrolyte membrane is formed by the gel membrane absorbs the liquid electrolyte D. The liquid electrolyte-containing gel electrolyte membrane has more excellent liquid absorption performance. The gel membrane which is grown in situ on at least one surface of the cathode and/or the anode, has large mechanical strength and has excellent interfacial compatibility and small interface resistance between the gel membrane and the cathode or the anode.

In the method for forming the liquid electrolyte-containing gel electrolyte membrane provided in the present disclosure, the mass fraction of the components of the liquid mixture C the liquid electrolyte D are further limited. Thus, the mass fraction of the components of the liquid mixture C the liquid electrolyte D is excellent.

In the method for forming the liquid electrolyte-containing gel electrolyte membrane provided in the present disclosure, the drying time, temperature, and pressure of the vacuum oven in the process of growing a gel membrane in situ on at least one surface of the cathode and/or the anode by the liquid mixture C are further limited. Thus, the structure and interfacial compatibility of the gel membrane are excellent.

In the method for forming the liquid electrolyte-containing gel electrolyte membrane provided in the present disclosure, which is laminating the gel membrane, the cathode and the anode to form a cell and injecting the liquid electrolyte D. It can obtain better electrochemical properties by using the above method.

In the method for forming the liquid electrolyte-containing gel electrolyte membrane provided in the present disclosure, the composition of polymer matrix, lithium salt, and organic solvent in the process are further limited. Thus, it need low requirements for environment of temperature and pressure.

The electrode assembly provided in the present disclosure, includes a cathode and/or an anode; and a liquid electrolyte-containing gel electrolyte membrane formed on at least one surface of the cathode and/or the anode; the liquid electrolyte-containing gel electrolyte membrane been formed by a liquid mixture C forming a gel membrane on the at least one surface of the cathode and/or the anode and absorbing a liquid electrolyte D. Thereby the interfacial compatibility of the electrode assembly is excellent.

The gel membrane provided in the present disclosure, has the porous network, and the liquid electrolyte-containing gel electrolyte membrane which has large mechanical strength, can be used in roll processing.

In the method for the gel electrolyte cell provided in the present disclosure, the liquid mixture C and the liquid electrolyte D are formed; a gel membrane is formed on at least one surface of the cathode and/or the anode by the liquid mixture C; a liquid electrolyte-containing gel electrolyte membrane is formed by what the gel membrane absorbs the liquid electrolyte D to form the gel electrolyte membrane, which provides the gel electrolyte membrane with a desired porous mesh structure by forming the gel electrolyte cell. With the method provided by the present disclosure, the gel electrolyte is easily formed on the surface of the cathode and/or the anode which has good compatibility with each other. The gel electrolyte membrane has more excellent liquid absorption performance, and there has excellent interfacial compatibility and small interface resistance between the gel membrane and the cathode or the anode. The gel membrane has large mechanical strength to form the gel electrolyte cell. In addition, it can be attained the optimum reaction conditions of the interface binding the gel membrane and the cathode or the anode, with the preparation of the liquid mixture C and the liquid electrolyte D separately. Thereby the yield of the gel electrolyte cell is improving.

The gel electrolyte cell provided in the present disclosure, includes a cathode, an anode, and a gel electrolyte membrane containing the liquid electrolyte resident therein. The liquid electrolyte-containing gel electrolyte membrane can homogenously grow on the surface of provided the cathode or the anode by coated the liquid mixture C and absorbing the liquid electrolyte D. Thereby improving the interfacial compatibility of the liquid electrolyte-containing gel electrolyte membrane with the cathode or the anode, absorption capacity, cycle performance and rate performance.

The gel polymer lithium-ion battery includes the liquid electrolyte-containing gel electrolyte membrane formed by the gel membrane absorbing the liquid electrolyte D. The liquid electrolyte-containing gel electrolyte membrane has excellent interfacial compatibility and small interface resistance between the gel membrane and the cathode or the anode. The gel membrane has large mechanical strength. Thus the safety and cycle performance of battery can be improved. The liquid electrolyte-containing gel electrolyte membrane has a high electrolyte conductivity (3 to 7*10-3 S·cm-1), a wide electrochemical window.

It is to be understood, however, that even though numerous characteristics and advantages of the present disclosure have been set forth in the foregoing description, together with details of the structure and function of the disclosure, the disclosure is illustrative only, and arrangement may be made in detail, especially in matters of shape, size, and arrangement of parts within the principles of the invention to the full extent indicted by the broad general meaning of the terms in which the appended claims are expressed.

What is claimed is:

1. A method for forming a liquid electrolyte-containing gel electrolyte membrane, comprising:
providing a cathode or an anode;
forming a liquid mixture C and a liquid electrolyte D;
forming a gel membrane on at least one surface of the cathode and/or the anode by the liquid mixture C; and
forming the liquid electrolyte-containing gel electrolyte membrane by the gel membrane absorbing the liquid electrolyte D;
wherein the liquid mixture C includes a liquid mixture A and a liquid mixture B, the liquid mixture A including a polymer matrix and an organic solvent, the liquid mixture B including an organic solvent and mixture additives, and the liquid electrolyte D includes a lithium salt, a plasticizer, and electrolyte additives.

2. The method of claim 1, wherein the liquid mixture C comprises 0.1 to 80% by mass fraction of the polymer matrix and 10 to 99% by mass fraction of the organic solvent; and 0 to 50% by mass fraction of the mixture additives,
the liquid electrolyte D comprises 0.1 to 50% by mass fraction of the lithium salt and 0.5 to 89% by mass fraction of the plasticizer, and 0 to 50% by mass fraction of the electrolyte additives.

3. The method of claim 1, wherein the liquid mixture C comprises 0.1 to 20% by mass fraction of the polymer matrix and 60 to 90% by mass fraction of the organic solvent; and 0 to 10% by mass fraction of the mixture additives,
the liquid electrolyte D comprises 0.1 to 20% by mass fraction of the lithium salt and 5 to 20% by mass fraction of the plasticizer, and 0 to 10% by mass fraction of the electrolyte additives.

4. The method of claim 1, wherein the gel membrane is formed on at least one surface of the cathode and/or the anode by the liquid mixture C by the following steps:
applying the liquid mixture C on at least one surface of the cathode and/or the anode;
drying the cathode and/or the anode at a temperature of −10 to 120° C. under a pressure of −5 to 5 Mpa, for 30 s to 24 h to form the gel membrane.

5. The method of claim 4, wherein the drying step is carried out in
a vacuum oven, and automatic ventilation is carried out for 0 to 100 times during drying in the vacuum oven to keep the organic solvent in the vacuum oven out of the oven.

6. The method of claim 1, wherein the liquid electrolyte-containing gel electrolyte membrane is formed by immersing the cathode and/or the anode with gel membrane formed thereon in the liquid electrolyte D for 1 s to 24 h.

7. The method of claim 1, wherein the liquid electrolyte-containing gel electrolyte membrane is formed by the following steps:
forming a cell without containing liquid electrolyte by packaging the cathode and the anode with the gel membrane formed thereon sandwiched between the cathode and the anode; and
injecting the liquid electrolyte D to the gel membrane of the cell.

8. The method of claim 1, wherein the polymer matrix is one or more materials selected from the following groups of polyvinyl chloride, chlorinated polyvinyl chloride, polystyrene, polyethylene oxide, polymethylmethacrylate, polyvinylidene fluoride, polyacrylonitrile, vinylidene fluoride-hexafluoropropylene copolymer, polyethylene, methyl methacrylate, and thermoplastic acrylic resin;
the organic solvent is one or more materials selected from the following groups of: acetone, N-methylpyrrolidone, anhydrous ethanol, dimethyl sulfoxide, dimethylformamide, tetrahydrofuran, and ethyl acetate;
the lithium salt is one or more materials selected from the following groups of: lithium hexafluorophosphate, lithium perchlorate, lithium hexafluoroarsenate, lithium tetrafluoroborate, lithium tetrachloroaluminate, lithium bistrifluoromethanesulfonylimide, lithium trifluoromethanesulfonate, lithium diboxylate, lithium tetrafluoroborate, lithium difluoroborate oxalate, lithium perfluoromethanesulfonate, lithium fluoride, lithium carbonate, and lithium chloride.

9. An electrode assembly comprising:
a cathode and/or an anode; and
a liquid electrolyte-containing gel electrolyte membrane formed on at least one surface of the cathode and/or the anode; the liquid electrolyte-containing gel electrolyte membrane been formed by a liquid mixture C forming a gel membrane on the at least one surface of the cathode and/or the anode and absorbing a liquid electrolyte D, wherein the liquid mixture C includes a liquid mixture A and a liquid mixture B, the liquid mixture A including a polymer matrix and an organic solvent, the liquid mixture B including an organic solvent and mixture additives, and the liquid electrolyte D includes a lithium salt, a plasticizer, and electrolyte additives.

10. The electrode assembly of claim 9, wherein the gel membrane has porous mesh structure, and a thickness of 10 to 200 μm.

11. The electrode assembly of claim 9, wherein the gel membrane has an electrolyte retention of up to 95%.

12. A method for forming a gel electrolyte cell, comprising:
providing a cathode and an anode:
forming a liquid mixture C and a liquid electrolyte D;
forming a gel membrane on at least one surface of the cathode and/or the anode by the liquid mixture C;
forming a liquid electrolyte-containing gel electrolyte membrane by the gel membrane absorbing the liquid electrolyte D;
forming the gel electrolyte cell by the liquid electrolyte-containing gel electrolyte membrane;
wherein the liquid mixture C includes a liquid mixture A and a liquid mixture B, the liquid mixture A including a polymer matrix and an organic solvent, the liquid mixture B including an organic solvent and mixture additives, and the liquid electrolyte D includes a lithium salt, a plasticizer, and electrolyte additives.

13. The method of claim 12, wherein
the cathode and/or the anode may be cut and pretreated prior to form a gel membrane on at least one surface of the cathode and/or the anode by the liquid mixture C.

14. The method of claim 12, wherein the liquid electrolyte-containing gel electrolyte membrane is formed by immersing the cathode and/or the anode with gel membrane formed thereon in the liquid electrolyte D for 1 s to 24 h.

15. The method of claim 12, wherein the liquid electrolyte-containing gel electrolyte membrane is formed by the following steps:
forming a cell without containing liquid electrolyte by packaging the cathode and the anode with the gel membrane formed thereon sandwiched between the cathode and the anode; and
injecting the liquid electrolyte D to the gel membrane of the cell.

16. A gel electrolyte cell, comprising:
a cathode and an anode, and a liquid electrolyte-containing gel electrolyte membrane sandwiched between the cathode and the anode, the liquid electrolyte-containing gel electrolyte membrane been formed by a liquid mixture C forming a gel membrane on at least one surface of the cathode and/or the anode, and absorbing a liquid electrolyte D, wherein the liquid mixture C includes a liquid mixture A and a liquid mixture B, the liquid mixture A including a polymer matrix and an organic solvent, the liquid mixture B including an organic solvent and mixture additives, and the liquid electrolyte D includes a lithium salt, a plasticizer, and electrolyte additives.

17. A gel polymer lithium-ion battery, comprising:
a gel electrolyte cell, wherein the gel electrolyte cell includes a cathode, an anode, and a liquid electrolyte-containing gel electrolyte membrane sandwiched between the cathode and the anode, the liquid electrolyte-containing gel electrolyte membrane been formed by a liquid mixture C forming a gel membrane on at least one surface of the cathode and/or the anode, and absorbing a liquid electrolyte D, wherein the liquid mixture C includes a liquid mixture A and a liquid mixture B, the liquid mixture A including a polymer matrix and an organic solvent, the liquid mixture B including an organic solvent and mixture additives, and the liquid electrolyte D includes a lithium salt, a plasticizer, and electrolyte additives.
